(19) United States
(12) Patent Application Publication
(10) Pub. No.: US 2006/0123909 A1
(43) Pub. Date: Jun. 15, 2006

(54) Method and arrangement for detecting parameters in displacement or angle sensors

(76) Inventors: Rasmus Rettig, Gerlingen (DE); Guenter Zwiener, Weil Der Stadt (DE); Karsten Schmidt-Grethe, Abstatt (DE); Christian Bauer, Schwieberdingen (DE)

Correspondence Address: STRIKER, STRIKER & STENBY, 103 EAST NECK ROAD, HUNTINGTON, NY, 11743, US

(21) Appl. No.: 11/271,062

(22) Filed: Nov. 10, 2005

(30) Foreign Application Priority Data
Dec. 15, 2004 (DE) 10 2004 060 299.9

(51) Int. Cl. G01P 3/44; G01B 7/30; G01B 21/22

(52) U.S. Cl. 73/514.39; 324/207.25

(57) ABSTRACT

In method and an arrangement for detecting parameters in displacement or angle sensors, in a test procedure sensor signals in a stationary sensor are evaluated, which signals are generated by scanning a plurality of code elements located side by side, perpendicular to a direction of motion, on a transducer element as a moving component; and the test procedure is performed with a transducer element that has a predetermined variation of geometrical variables of the code elements.

### BACKGROUND OF THE INVENTION

The present invention relates to a method and an arrangement for detecting parameters, in particular the air gap in magnetic sensor arrangements, in displacement or angle sensors.

It is known per se that for detecting rotary speeds or rotational angle changes, for instance in motor vehicles, rpm sensors are used for measuring the rotary speed of wheels, for electronic stability control systems, or in engine control. These sensors can evaluate an angular position, for instance, on the basis of pulses generated optically, magnetically, or otherwise, by the rotation and detected by suitable means.

Particularly in magnetic measuring methods, knowledge of the maximum allowable air gap between the transducer element and the sensor is very important, if a reliable measurement method is to be obtained. The maximum allowable air gap, in the applications described above, is the air gap at which it is assured that under all operating conditions, every mechanical or magnetic flank, for instance of a transducer wheel provided with tooth flanks, is detected and output by the sensor.

In the manufacture of such rpm sensors, typically a defined test air gap is established between the transducer wheel and the sensor for every sensor produced. If the sensor correctly reflects all the flanks of the transducer wheel, the outcome of the test is positive. The test air gap is selected such that in the ensuing operation, the function is assured under all peripheral conditions.

This test is typically designed as a so-called go/no-go test and furnishes no quantitative information whatever about the air gap actually attainable with the particular sensor. The go/no-go test method, however, is in no way appropriate for the importance of the air gap as a parameter in production, since with it, static detection and if needed correction of the production process, for instance, is not possible.

### SUMMARY OF THE INVENTION

It is therefore an object of the present invention to provide a method and arrangement for detecting parameters in displacement or angle sensors which avoid the disadvantages of the prior art.

In keeping with these objects and with others which will become apparent hereinafter, one feature of the present invention resides, briefly stated, in a method for detecting parameters in displacement or angle sensors, comprising the steps of evaluating in a test procedure, sensor signals in a stationary sensor, which signals are generated by scanning a plurality of code elements located side by side, perpendicular to a direction of motion, on a transducer element as a moving component; and performing the test procedure with the transducer element that has a predetermined variation of geometrical variables of the code elements.

When the method is performed in accordance with the present invention, a test procedure is advantageously performed in which sensor signals are evaluated in a stationary sensor, which signals are generated by scanning of a plurality of code elements, located side by side, perpendicular to the direction of motion, on a transducer element as a moving component. The test procedure is performed with a transducer element that has a predetermined variation of the geometric variables of the code elements.

Preferably, the proposed method serves to detect the air gap that occurs between a magnetic-field-sensitive sensor and a tooth-gap contour on the transducer element as a parameter, and the tooth height and/or gap height is varied in a predetermined order.

With the invention, a test method can advantageously be implemented which makes a quantitative determination of the attainable air gap possible for each sensor manufactured. The test procedure is not lengthened in duration by this. In this way, it is thus possible at minimal additional expense to detect the attainable air gap statistically during production and use it for both controlling and optimizing the production processes.

In an advantageous embodiment of the invention, the transducer element is a transducer wheel, and the test procedure is effected during one wheel revolution, identified by means of an index marking.

A variant of the invention may be designed in such a way that the variation in the tooth height and/or gap depth is embodied such that during the test procedure, a continuous enlargement of the air gap occurs. However, it is especially advantageous if the variation in the tooth height and/or gap depth is embodied such that during the test procedure, a groupwise enlargement of the air gap takes place; for instance, four groups, each with tooth heights and/or gap heights that repeat four times, may be located on the circumference of the transducer wheel during the test procedure.

In an advantageous arrangement for performing the above-described method, there is a test apparatus which uses a metal transducer wheel, produced for the test procedure, which has the varied tooth-gap contour on its circumference. The tooth-gap contour is located across the air gap opposite an rpm sensor, and the beginning of the test procedure can be defined via an index hole, as an index marking.

The novel features which are considered as characteristic for the present invention are set forth in particular in the appended claims the invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a basic arrangement of a magnetic field sensitive rpm sensor, which is diametrically opposite, across an air gap, from a tooth-gap contour of a transducer wheel;

FIGS. 2 and 3 each show a transducer wheel for a test procedure, with a groupwise variation in the tooth-gap contour of the transducer wheel;

FIG. 4 shows the course of measurement and sensor signals during a test procedure, or one revolution of the transducer wheel of FIG. 2; and

FIG. 5 shows the course of the magnetic differential field during the test procedure.

### DESCRIPTION OF THE PREFERRED EMBODIMENTS

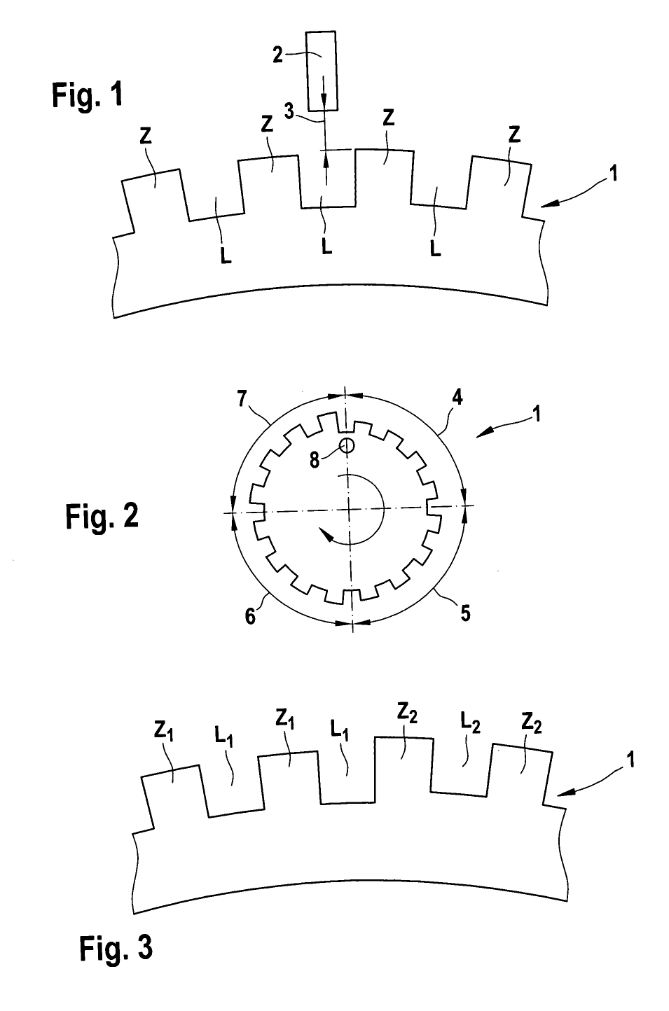

In FIG. 1, in a schematic view, part of a transducer wheel 1 is shown, which is provided on its circumference with a tooth-gap contour Z, L. There is also a magnetic-field- sensitive sensor 2, as an rpm sensor, which is diametrically opposite the tooth-gap contour Z, L across an air gap 3. As the transducer wheel 1 below the sensor 2 rotates past it, the switching edges that are tripped by the field variation on the part of the tooth-gap contour Z, L, can be evaluated, if the size of the air gap 3 permits the generation of a sensor output signal.

In a test apparatus, a qualitative effect of the air gap 3 is now to be performed by measurement with a transducer wheel 1 of FIG. 2 and FIG. 3; this measurement can be achieved with an arbitrary sensor configuration. To that end, the transducer wheel 1 of FIG. 2 has a variation in the tooth-gap contour in terms of the height of both the teeth Z and the gaps L. In this transducer wheel 1, there are four periods 4, 5, 6 and 7, each with four approximately equal teeth and tooth-gap heights Z1, L1; Z2, L2; Z3, L3; Z4, L4 located on the circumference. Moreover, via an index hole 8, an index marking or reference position is set for the beginning of a test procedure or of a revolution. The beginning of the test procedure can then be detected, for instance by a light gate.

From FIG. 3, one tooth-gap group with Z1 and L1 and one group with tooth-gap heights Z2 and L2 differing from it can also be seen in detail.

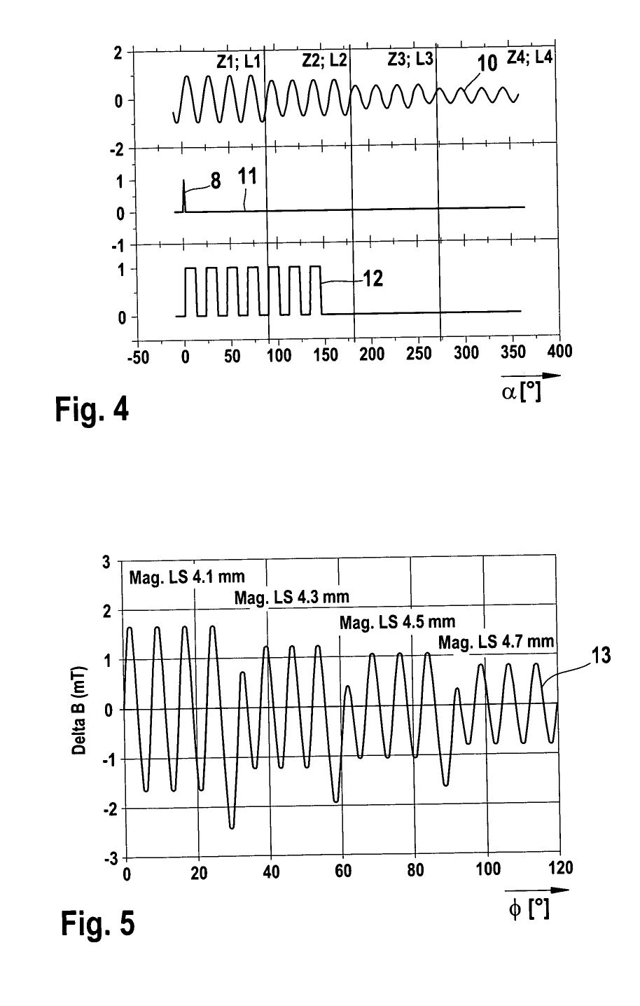

In FIG. 4, the magnetic field 10, the index signal 11, and the output signal 12 of the sensor are shown over the rpm a and a revolution of the transducer wheel 1. The variation in the tooth-gap contour Z, L, in the exemplary embodiment shown, is emphasized in such a way that after the traversal through the index marking 8 (index signal 11), initially a slight air gap 3 with a tooth-gap height Z1, L1 is established between the sensor 2 and the transducer wheel 1. In the rotation of the transducer wheel 1 past the sensor, by reducing the tooth-gap height from Z2, L2 after the index position through Z3, L3 to Z4, L4, an increasing air gap 3 is established, and decreasing field fluctuations in the course 10 are generated.

In the process, the output signals of the sensor 2 are evaluated by means of the pulses 12. As soon as a flank or a pulse is missing as an output signal of the sensor 2 is missing, then either the time since the passage past the index marking 8 or alternatively the rotational angle α is stored in memory. On the condition that the rotational speed of the transducer wheel 1 is constant, an unambiguous association with the air gap 3 and thus with the magnetic amplitude 10 is thus possible.

In designing the variation in the tooth-gap contour of the transducer wheel 1 over its circumference, calibration algorithms internal to the sensor may be taken into account. In the exemplary embodiment of FIG. 2, with four periods, each with four identical tooth-gap pairs, the sensor 2 can adapt by internal adaptation to the magnetic stimulation before the air gap 3 is artificially increased still further. Moreover, the conclusiveness of the measurement is improved by the repetition of identical tooth-gap pairs.

In the test procedure of FIG. 4, the sensor 2 furnishes correct signals up to the angular position α=150° and does not fail until at an air gap 3 corresponding to Z2, L2, while Z1, L1 is still evaluated correctly.

In FIG. 5, the simulated course 13 of the differential magnetic field Delta B is shown for a differential magnetic field sensor 2 with air gap heights of 4.1 mm, 4.3 mm, 4.5 mm, and 4.7 mm. From this, the influence can be seen that is exerted by the nonideal periodicity of the transducer wheel 1 at the beginning and end of each of the four groups. This can be suitably taken into account in the design of the transducer wheel 1 constructed for the testing. By changing the tooth-gap contour Z, L at the transition between groups, the overswings and underswings apparent here can be minimized in their amplitude.

It will be understood that each of the elements described above, or two or more together, may also find a useful application in other types of methods and constructions differing from the types described above.

While the invention has been illustrated and described as embodied in method nd arrangement for detecting parameters in displacement or angle sensors, it is not intended to be limited to the details shown, since various modifications and structural changes may be made without departing in any way from the spirit of the present invention.

Without further analysis, the foregoing will reveal fully revela the gist of the present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims:

1. A method for detecting parameters in displacement or angle sensors, comprising the steps of evaluating in a test procedure, sensor signals in a stationary sensor, which signals are generated by scanning a plurality of code elements located side by side, perpendicular to a direction of motion, on a transducer element as a moving component; and performing the test procedure with the transducer element that has a predetermined variation of geometrical variables of the code elements.

2. A method as defined in claim 1; and further comprising, for detecting a parameter that is an air gap, which occurs between a magnetic-field-sensitive sensor and an n-fold tooth-gap contour as a code element on the transducer element, varying a tooth parameter selected from the consisting of a tooth height, a gap height, and both in a predetermined order.

3. A method as defined in claim 2; and further comprising forming the transducer element as a transducer wheel; and effecting the test procedure during one wheel revolution, starting by an index marking.

4. A method as defined in claim 2; and further comprising embodying the varying in the tooth height, the gap height or both such that during the test procedure, a continuous reduction of the air gap is effected by increasing gap tooth and gap heights.

5. A method as defined in claim 2; and further comprising performing the varying in the tooth height, the gap height or both such that during the test procedure, a continuous increase of the gap is provided by means of decreasing tooth and gap heights.

6. A method as defined in claim 2; and further comprising performing the varying in the tooth height, the gap height or both such that during the test procedure groups of identical tooth-gap heights are formed.

7. A method as defined in claim 6; and further comprising locating four groups each with tooth heights, gap heights or both that repeat four 4 times on a circumference of the transducer element formed as a transducer wheel.

8. A method as recited in claim 2; and further comprising after a traverseal of the index marking, establishing a slight air gap first with a first tooth-gap height between the sensor and the transducer wheel; and as the transducer wheel rotates past the sensor, providing an increasing air gap which results from a reduction in following tooth-gap heights; and a result of a decreasing fluctation at the sensor, providing evaluation of the pulses at an output of the sensor so as to obtain a time or a rotation angle since the wheel passed said index marking is stored in memory.

9. A method as defined in claim 8; and further comprising adapting a tooth-gap contour at a beginning and an end of the groups, to minimize overswings and underswings in amplitude.

10. An arrangement for detecting parameters in displacement or angle sensors, comprising means for evaluating in a test procedure sensor signals in a stationary sensor, which signals are generated by scanning a plurality of code elements located side by side, perpendicular to a direction of motion, on a transducer element as a moving component, said means being formed to perform the test procedure with the transducer element that has a predetermined variation of geometrical variables of the code elements.

11. An arrangement as defined in claim 10, wherein the transducer element is formed as a metal transducer wheel which has on its circumference a varried tooth-gap contour which is opposite to the sensor formed as an rpm sensor over an airgap; and an index hole defining a beginning of the test procedure.
